(19) United States
(12) Patent Application Publication
(10) Pub. No.: US 2004/0256163 A1
(43) Pub. Date: Dec. 23, 2004

(54) Optical scale

(76) Inventor: Robert K. Thomson, Mountain View, CA (US)

Correspondence Address: Robert K. Thomson, 706 Mariposa Avenue, Unit 3, Mountain View, CA, 94041, US

(21) Appl. No.: 10/601,060

(22) Filed: Jun. 23, 2003

(51) Int. Cl. G01G 23/30

(52) U.S. Cl. 177/177

(57) ABSTRACT

The present invention is a scale to be mounted onto a load-bearing member of a vehicle, structure or other entity supporting a load to be measured. The invention uses optics to measure the flexure of the loaded structural member. The flexure is proportional to the weight of the load. Associated electronics amplify the optical output signals, feed back one to compensate for temperature variations, convert the other to digital to drive a readout device that displays the resultant weight figure.

### FIELD OF THE INVENTION

This invention relates to an apparatus for the measurement of weight by sensing the deflection in a structural member bearing the weight.

### BACKGROUND OF THE INVENTION

The ability to measure large weight in dynamic applications offers a hedge against many hazards. Safety applications include disabling a vehicle or alarming structure at the point where loading becomes excessive, as well as scales for remotely controlled vehicles in toxic environments. Uses include freight-hauling or material-moving trucks. Other applications will be readily apparent to those skilled in the art and are included in the spirit of the present invention.

These applications present common requirements. Such scales must be rugged, reliable, accurate, cost effective, and protected from overloads.

### SUMMARY OF THE INVENTION

The present invention is a reliable, low-cost, non-overloading scale for dynamic applications. In one embodiment, the invention is a rugged tube with optics fixed facing one another from the inside of each end. The tube mounts to a structural member that is flexed by the weight to be measured. The optical emitter in one end of the tube radiates a beam through an aperture to the sensor at the opposite end of the tube. The tube flexes with the structural member to which it is attached as the member is loaded. Bending the tube moves the emitted light across the face of the sensor, creating an electrical signal. The signal is proportional to the flexure of the tube, which is proportional to the applied weight. The signal is amplified to drive readout and other user-defined electronics.

### BRIEF DESCRIPTION OF FIGURES

FIG. 1 shows emitter intensity as a function of the angular deviation from beam center.

FIG. 2 shows the large beam angle where the sensor and emitter are placed close together.

FIG. 3 shows the small beam angle where the optical devices are mounted well apart.

FIG. 4 shows the effect of heat on the output linearity of optical devices.

FIG. 5 shows the effect of heat sinking on the optics output.

FIG. 6 is an isometric view of one embodiment.

FIG. 7 shows an embodiment of the present invention, optics not installed.

FIG. 8 shows an embodiment of the present invention mounted on a structural member.

FIG. 9 shows a top view and aperture of the embodiment.

FIG. 10 shows the aperture (44) as viewed from the top with the embodiment mounted to a structural member.

FIG. 11 shows the tube bore as seen from the left, or sensor mounting, end.

FIG. 12 shows the tube bore as seen from the emitter end.

FIG. 13 shows aperture moved downward when the tube is flexed.

FIG. 14A shows a side view of the embodiment with the optics mounted.

FIG. 14B shows the sensor mounted in the bore of the tube.

FIG. 14C shows the emitter mounted in the bore of the tube.

FIG. 14D shows the light-beam limiting aperture.

FIG. 15 shows that the embodiment need not be centered on the beam or under the load.

FIG. 16 shows the embodiment in operation, no load.

FIG. 17 shows a top view of the embodiment.

FIG. 18 shows tube flexure under load and the movement of the beam down the face of the array.

FIG. 19 shows the light beam on the face of the sensor array when the scale is not loaded.

FIG. 20 shows the light beam moved downward on the array face when the scale is loaded.

FIG. 21 shows a flow diagram according to one embodiment.

### DETAILED DESCRIPTION OF AN EMBODIMENT

The following description illustrates the invention by way of example, not by way of limitation of the principles of the invention. This description will clearly enable one skilled in the art to make and use the invention, including what is presently believed to be the best mode of carrying out the invention.

Device Linearity

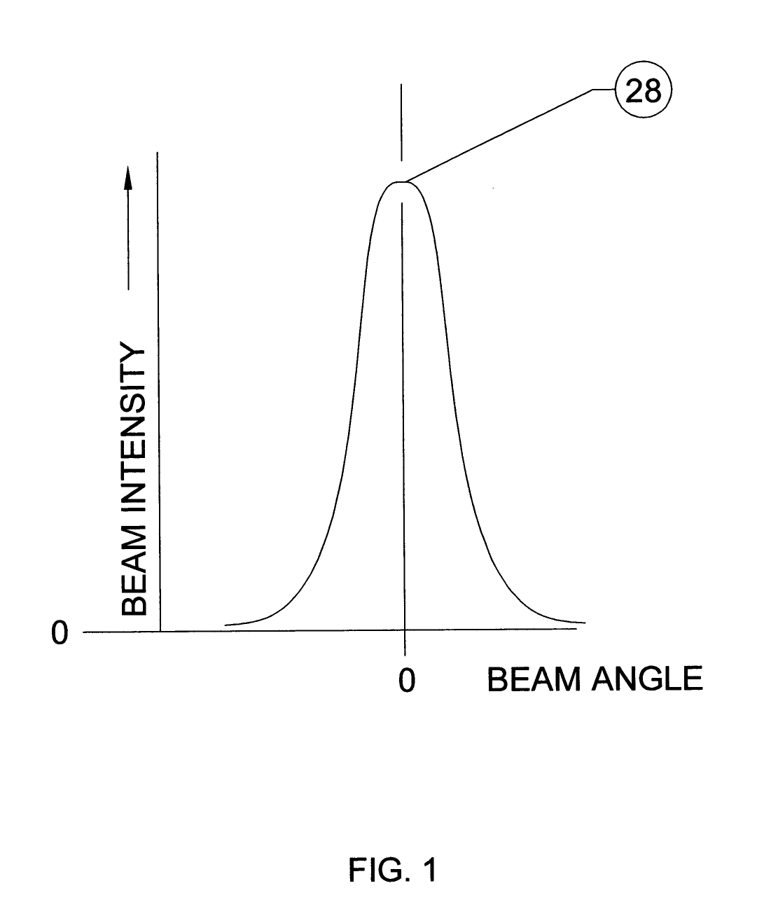

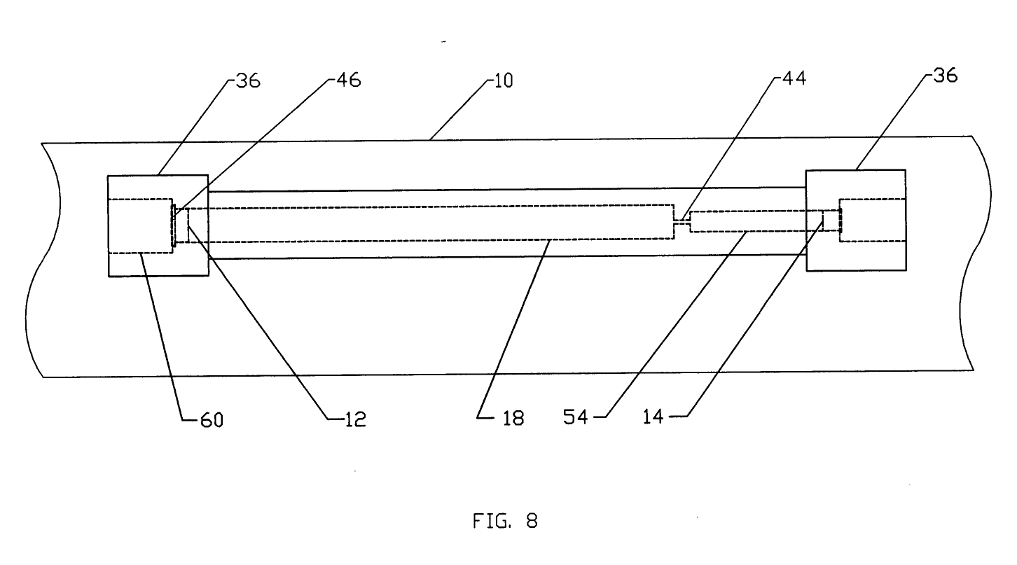

In one embodiment, shown in FIG. 8, a light sensor (12) and a light emitter (14) are mounted facing each other at opposite ends of a bore (40) cut through a tube (38) parallel to its longitudinal axis. The major dimension of the invention thus separates the emitter and sensor. The separation assures that optical measurements will be made in the small area about zero (28) of the beam angle wherein the light intensity is linear. The small area (28) is shown in FIG. 1A.

Inherent in the use of optics as measuring devices is the non-linearity across their full area of emission. The intensity of the emitting means is not linear as an angle measured from the center to the peripheral of the emitted beam. As shown in FIG. 1, intensity of the beam decreases as the angular distance from the center of the beam increases. Moreover, the decreasing intensity is non-linear. Only within a small portion (28) of the beam angle near the centerline of the beam is the beam of uniform intensity.

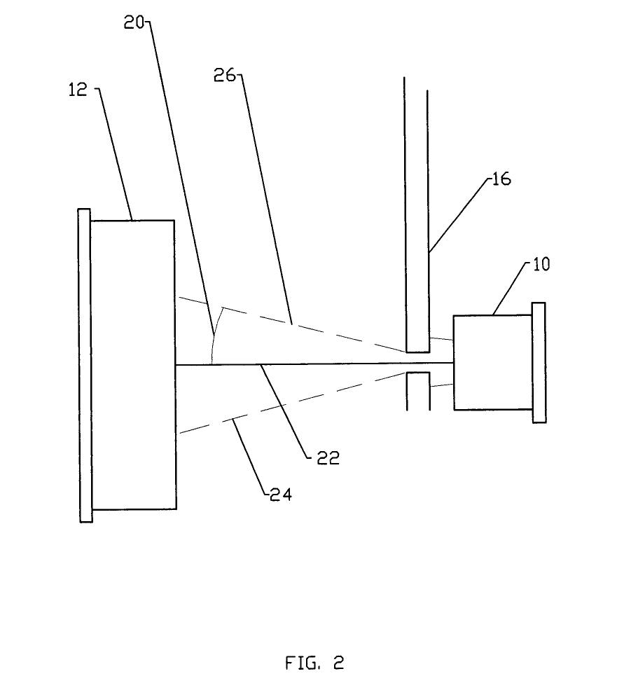

The nearer the optical devices are to each other, the larger the beam angle, and therefore the larger the non-linearity. FIG. 2 is an illustration of the large beam angle used when emitting and sensing devices are in close proximity. If the design limited the distance between the emitting and sensing device, non-linearity would be unavoidable.

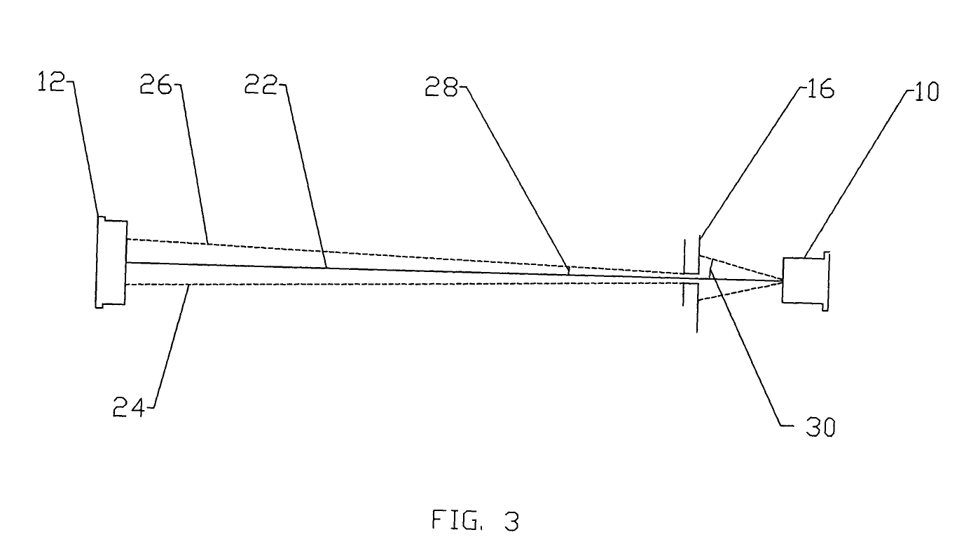

FIG. 3 is an illustration of the small beam angle existent in the embodiment of the present invention due to the separation of the optics. The embodiment uses only the small portion (28) of the full emission angle (30) wherein the device is linear.

By positioning the optical devices (12) and (14) at the opposite ends of the bore (40), maximum separation is achieved. The separation decreases the angle between the center of the emitted beam and the furthest point from beam center that is involved in the function. The entire range of measurement is within the small angle (28) as shown in FIG. 1 wherein the emitter output intensity is linear. Beam-angle non-linearities are eliminated. Further, that dimension may be increased with no limitation inherent in the design.

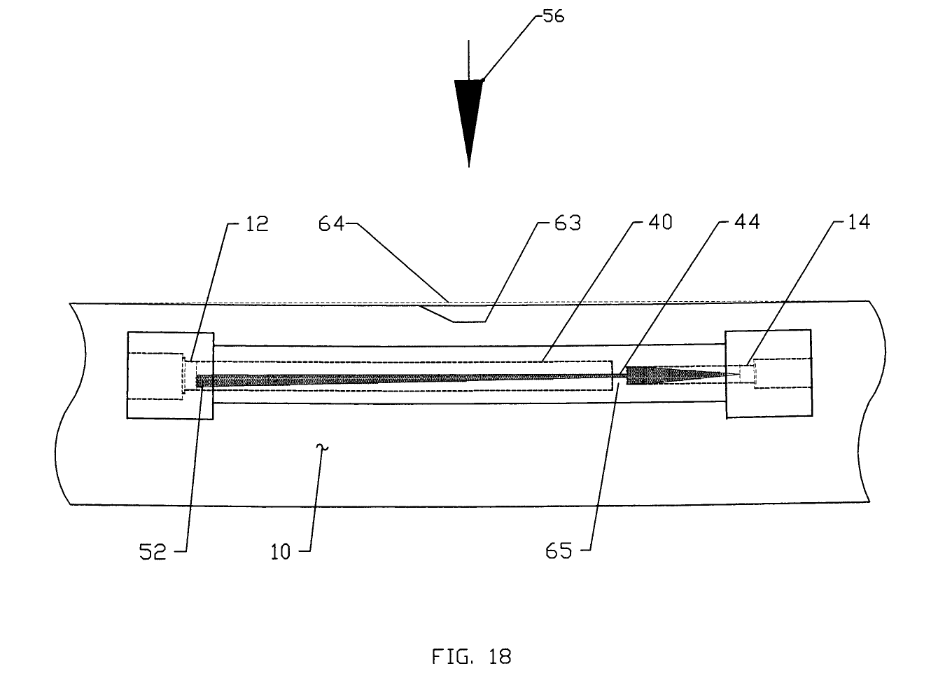

The dimensions of the tube vary with the amount of flexure of the load-bearing member to which the tube is attached. The distance between the emitter (14) and aperture (44) adjusts the dimension of the beam, which is parallel to the applied force. This dimension must be large enough to prevent the beam from crossing the horizontal division of the devices in the photoelectric cell array when the tube is fully deflected as shown in FIG. 18.

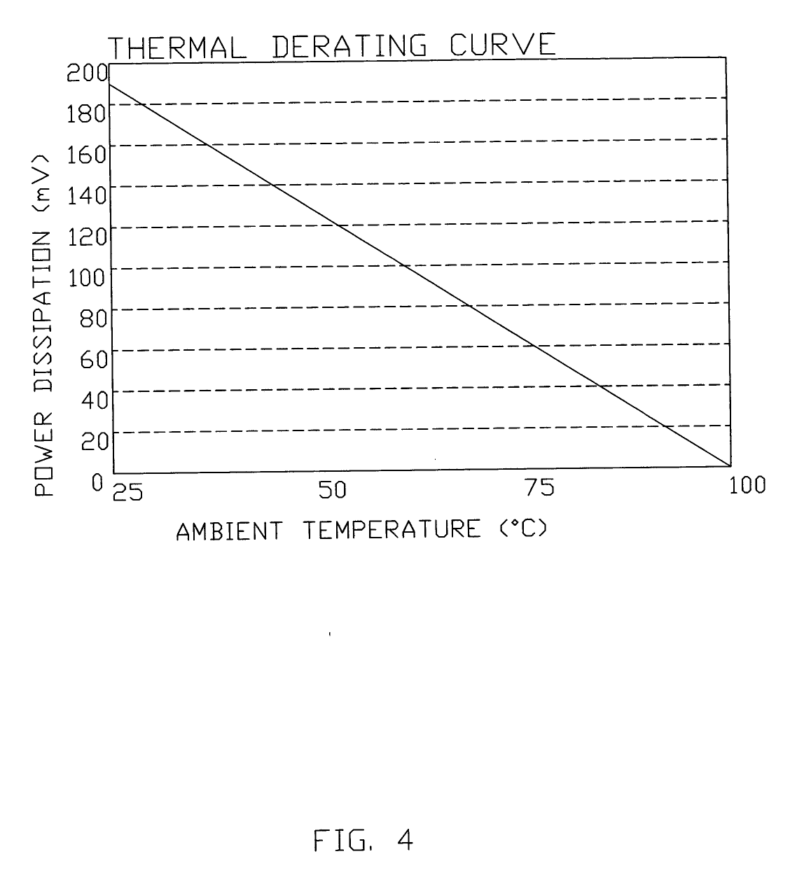

Also inherent in the optics is the change in output caused by temperature variations. The emission device output varies with the temperature as shown by FIG. 4. With no heat sinking, the temperature varies from moment to moment, causing a non-correctable error in output intensity, and hence, in the weight measurement.

The embodiment of the present invention utilizes the mass of the structure itself as a heat sink. The optics are mounted in contact with the durable, flexible material of the invention, which is, in turn, mounted onto the durable flexible material of the structure supporting the weight to be measured. In effect, the entire mass of the structure is a heat sink for the optical devices.

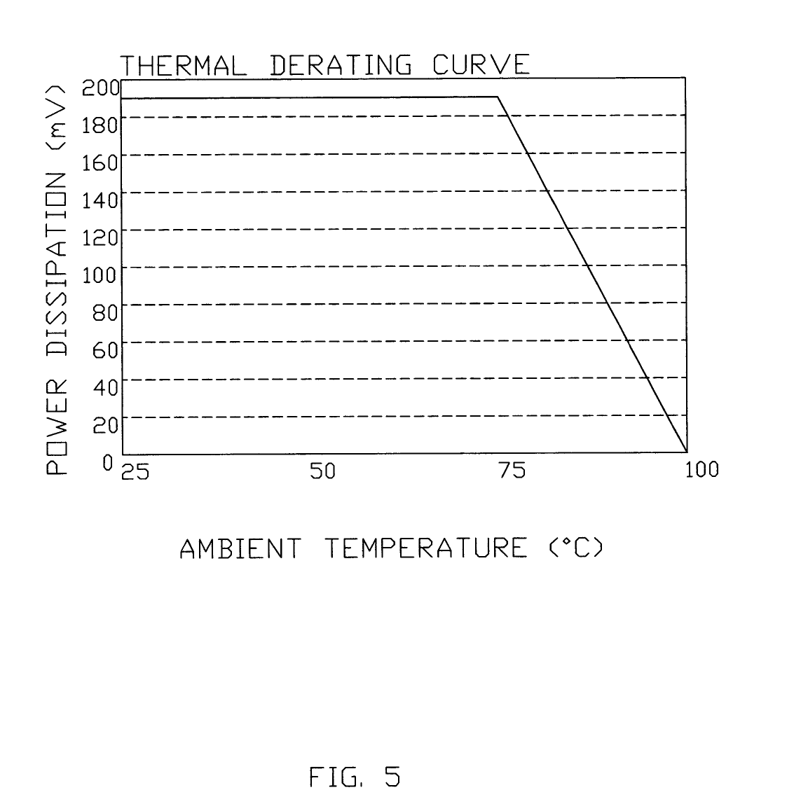

As shown in FIG. 5, heat sinking holds the temperature of the emitting device to ambient temperature. Such changes are slow and can be neutralized by periodic adjustments. In addition, the embodiment uses two of the four photoelectric cells to further neutralize the effects of temperature change. One cell of the upper set and one cell of the lower set are summingly amplified to provide a temperature correction signal.

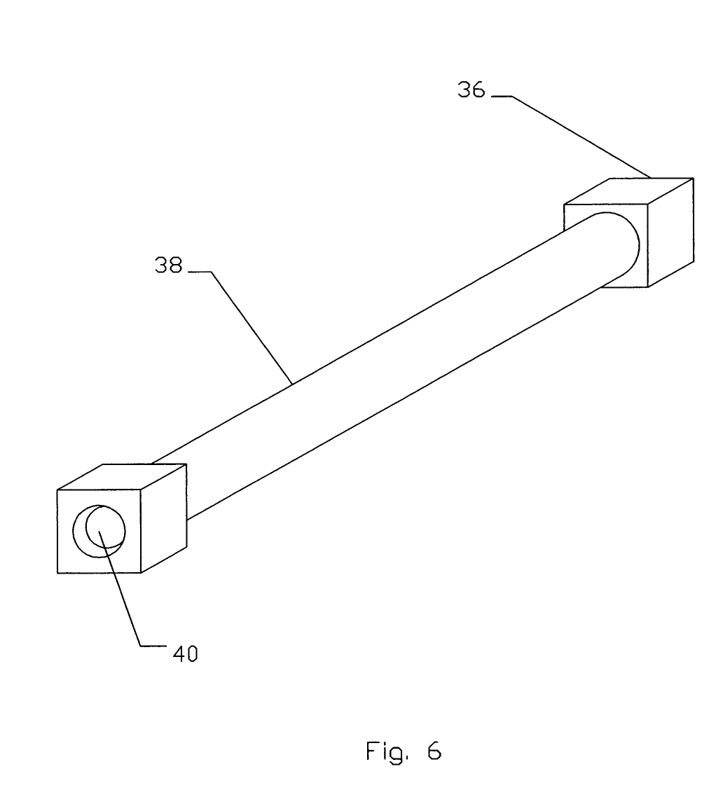

FIG. 6 is a rough sketch of the unmounted device showing the blocks (36), tube (38), and bore (40).

Physical Description

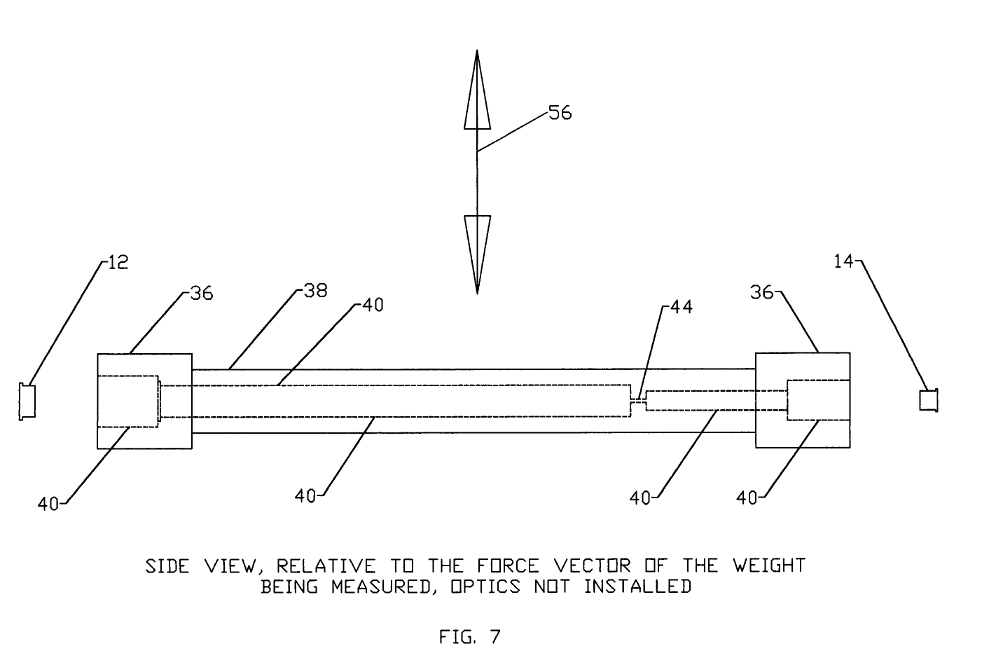

Shown in FIG. 7 is a tube (38) having squared ends (36) and a bore (40) of varying diameters parallel to its longitudinal axis and constricting at a point to form an aperture (44). Emitter (14) and sensor (12) are shown near their respective mounting ends, but are not mounted.

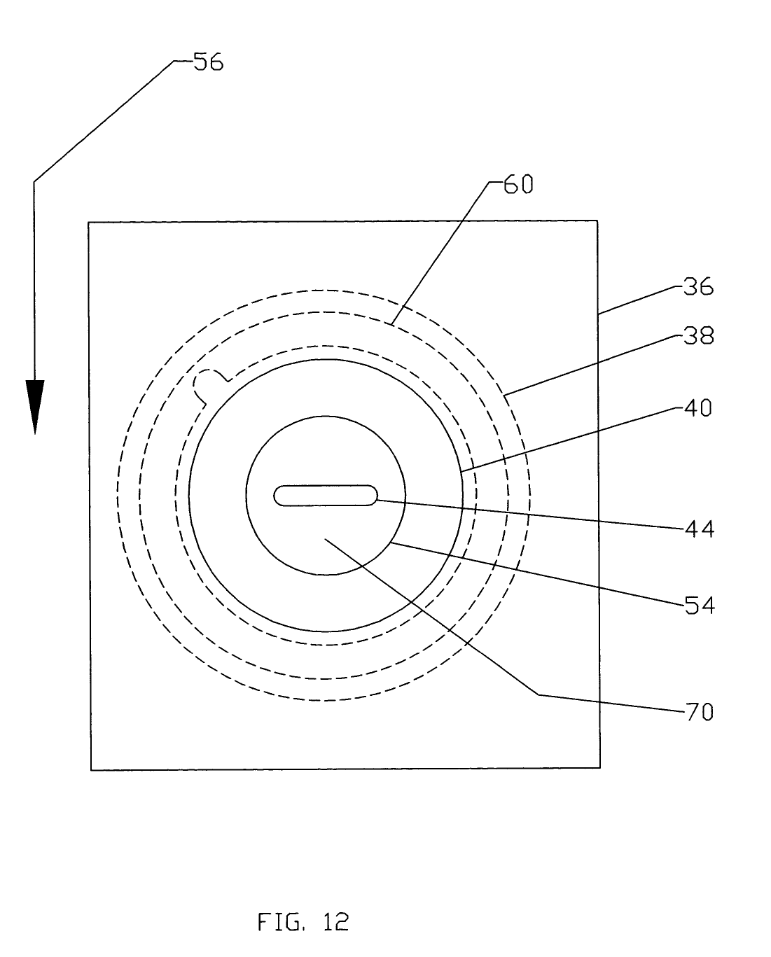

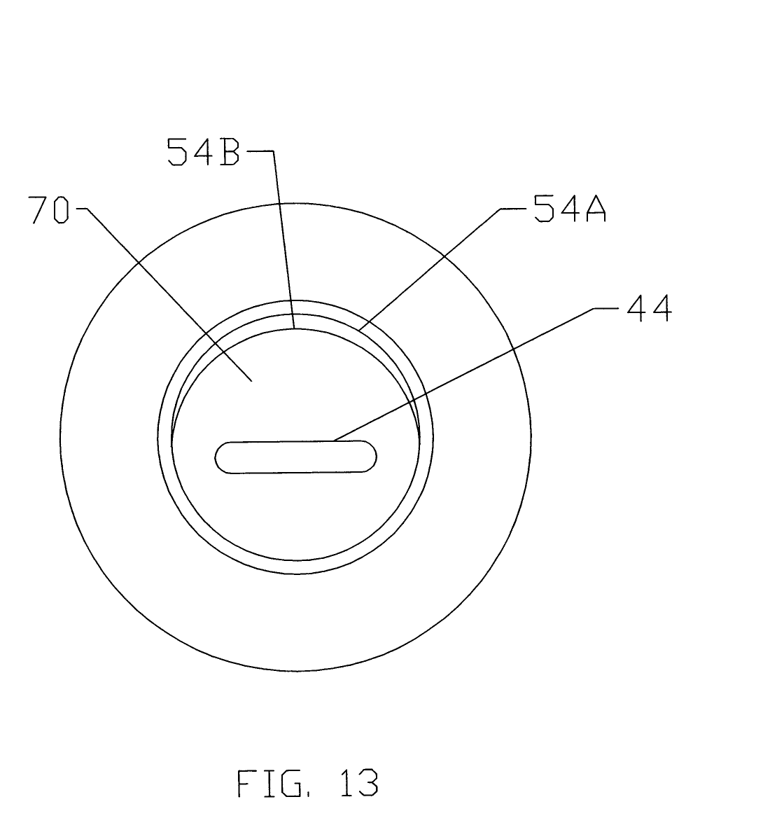

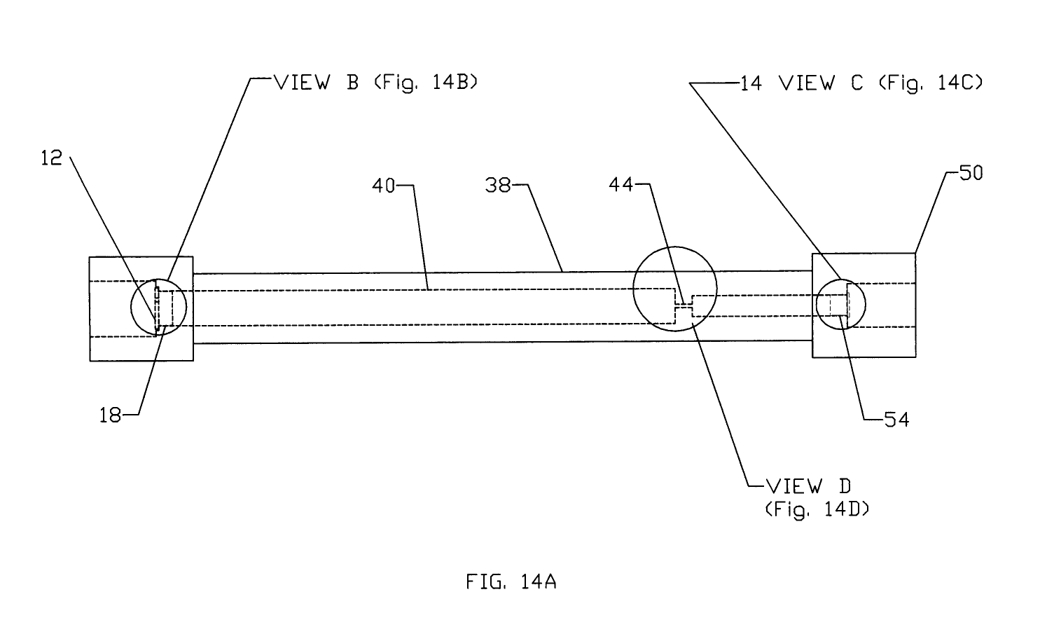

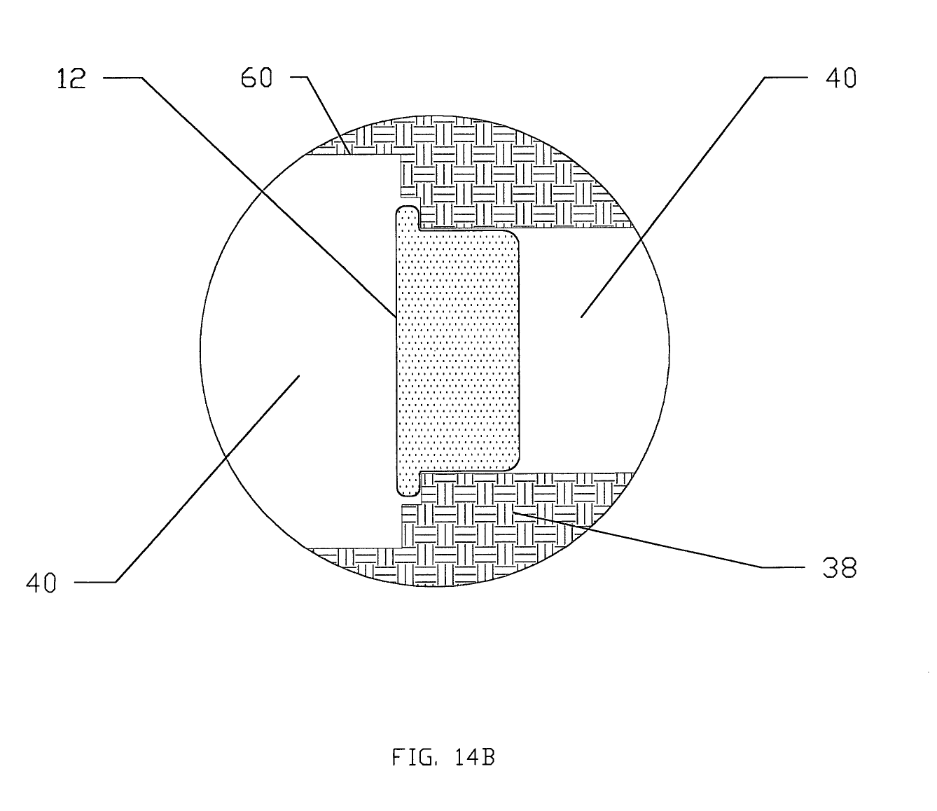

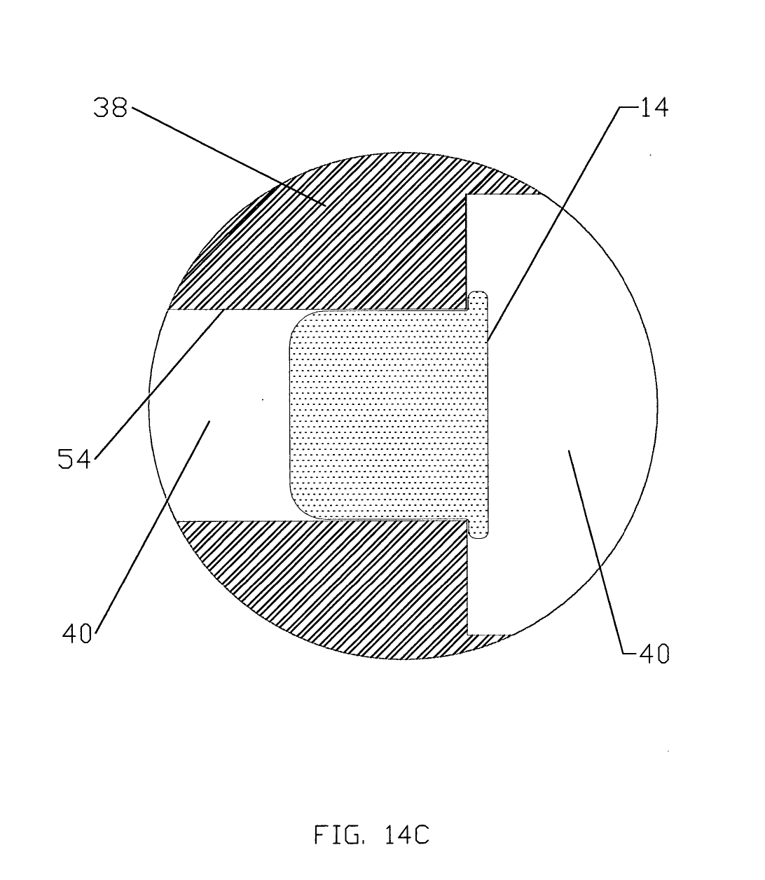

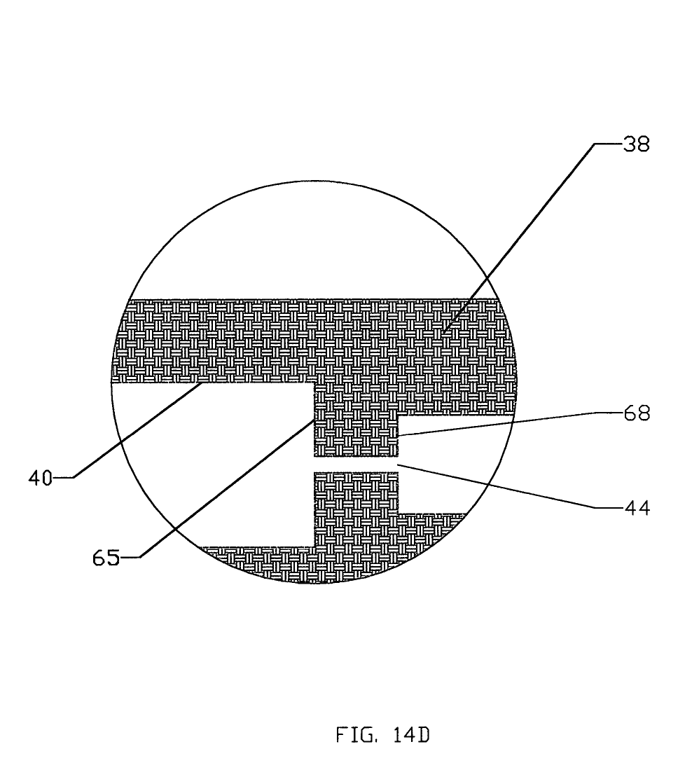

As shown in FIG. 8, a sensor array package (12) is inserted into the bore opposite of and facing an emitter (14) similarly positioned in into the bore (40) beyond aperture (44). The photocell array package is fixed in place by the tight-fitting diameter (18) of the through bore (40). The emitter is positioned by the tight-fitting diameter (54). Shown in FIGS. 12 and 14B, bore diameter (60) provides an access hole for mounting the photoelectric cell array.

The aperture (44) may be formed of the material of the tube, or it may be fashioned separately and mounted into the bore. The methods will vary, and all of these methods and positions are included in the spirit of the present invention.

The scale (42) is suspended by squared blocks (36) on either end. The blocks position the horizontal and vertical alignment of the photoelectric cell array (12).

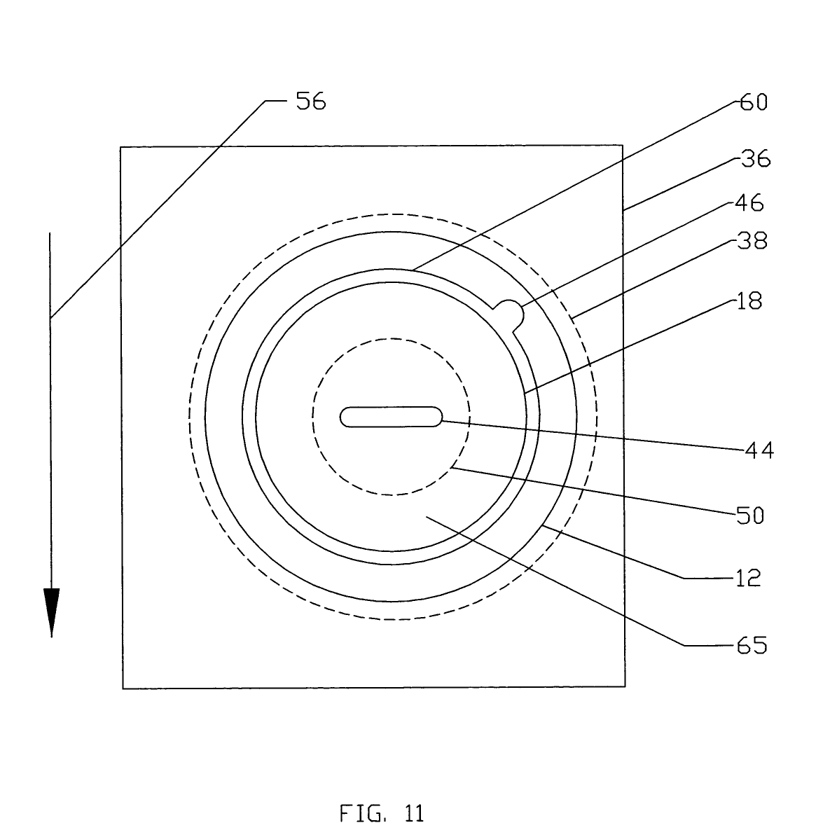

Shown in FIGS. 11 and 14B, a bore diameter (60) provides an access hole for mounting the photoelectric cell array package. It is not a critical dimension. Diameter (18) is critical, as it positions the array (12) in relation to the bore (40) and aperture (44) by fitting snugly against the barrel of the array package. FIG. 14B shows the package (12) fitted into the bore (18). The O.D. (13) of the package barrel and the I.D. (18) of the bore are shown as cylindrical surfaces. The barrel, however, is often tapered slightly. When using a tapered package, the bore I.D. in the mounting surface will have to have a matching taper.

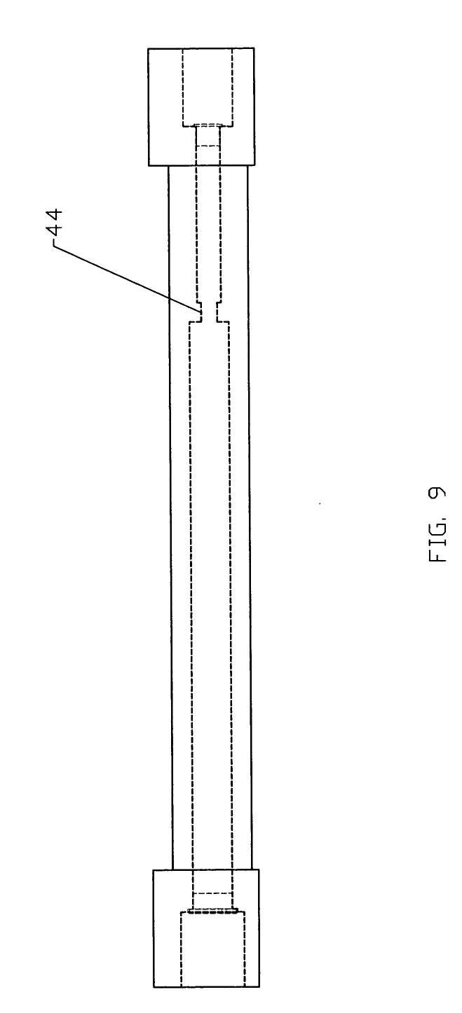

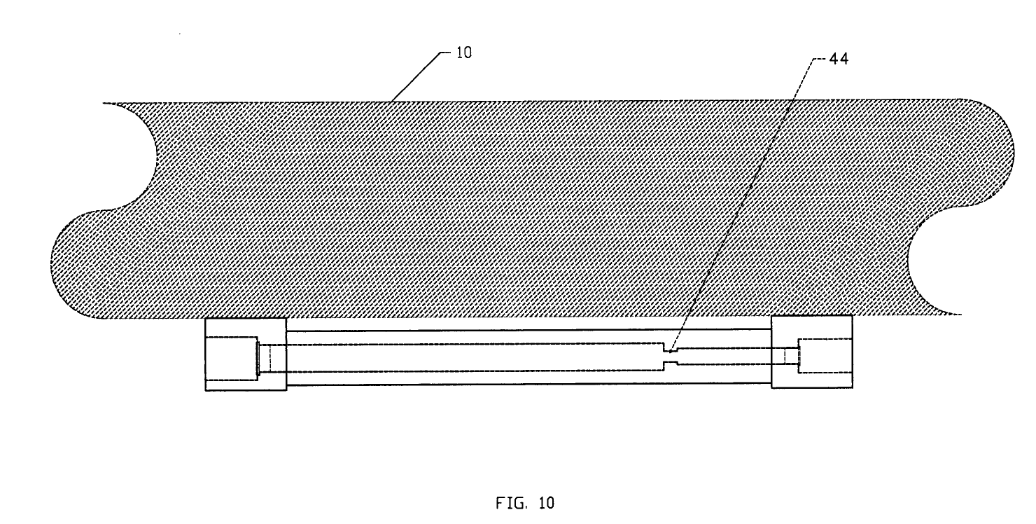

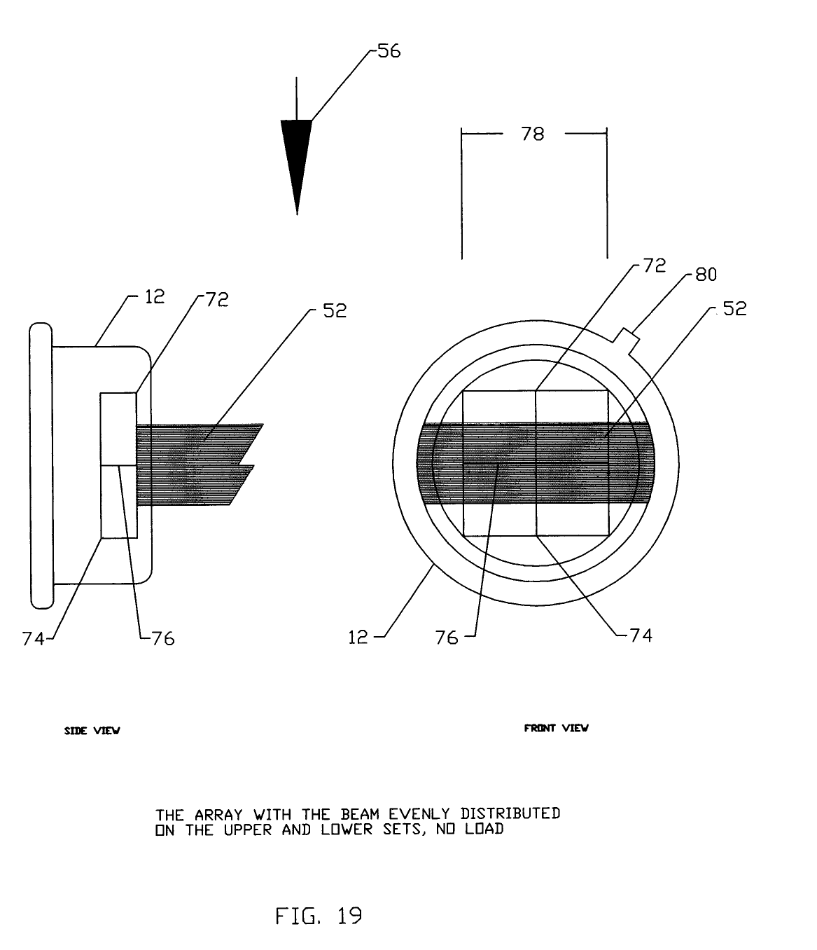

Shown in FIG. 9 is an embodiment of the present invention as viewed from the direction of the applied force (56). The width of the aperture (44) passes a wide beam of light (52) aligned with the horizontal separation of the sensor in the sensor array. As seen in FIG. 19, the width of the beam exceeds the width (78) of the photoelectric cell array (72) inside the package (12). This eliminates the introduction of error if the horizontal division between the photoelectric cells is not precisely at 90° to the weight vector.

FIG. 11 is the bore as seen from the sensor-mounting end, package omitted for clarity. A small, precisely positioned slot (46) made in the array-package flange-seating diameter (60) parallel to the axis of the through bore. The slot is only slightly larger than the tab (80) on the circumference of the sensor-array package marking its pin one. The slot (46) affixes the tab (80) shown in FIG. 19 on the array package, thereby aligning the array. A division of the cells (76) separates the upper two-cell set (72) from the lower two-cell set (74), again as shown in FIG. 19. The alignment is such that the force (56) to be measured is approximately transversely applied in relation to the division of the cells (76).

FIGS. 11 and 12 show the aperture (44) with its wide dimension at 900 to the direction of the weight vector (56). FIG. 12 shows the bulkhead (70) as seen from the emitter end with aperture (44), no load applied. The aperture is at the centerline.

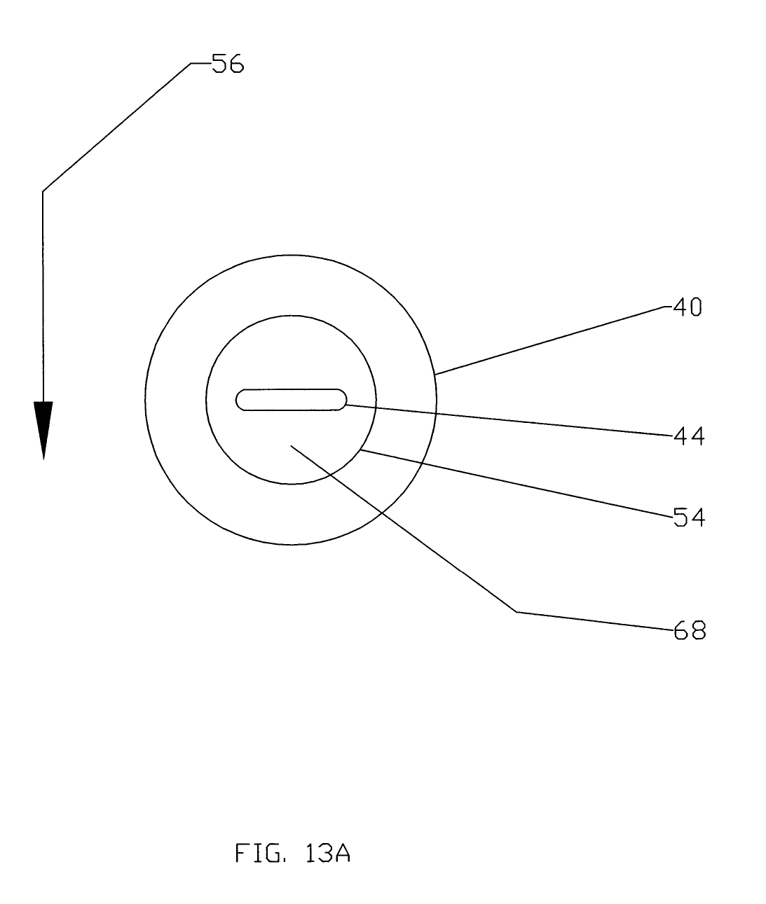

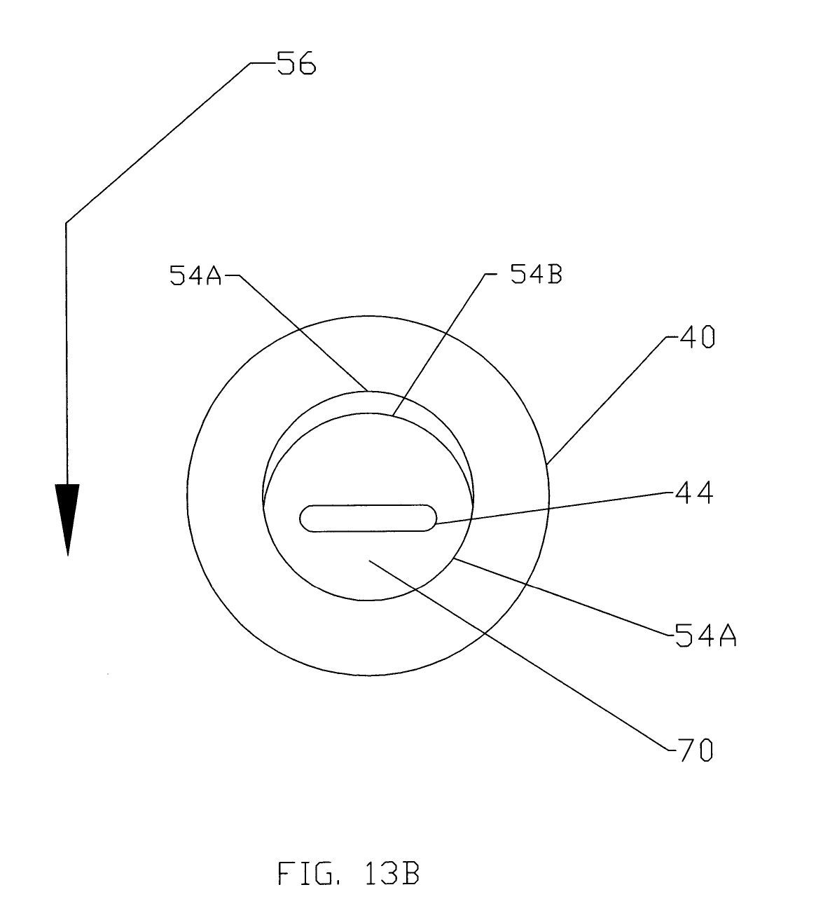

FIG. 13A and 13B are the same view as FIG. 12, but with the block (36) and hidden lines omitted for clarity. FIG. 13A is a view into the bore under no-load conditions. Note that the aperture (44) is centered. FIG. 13B is a view into the bore with the scale loaded. The circle (54A) is the emitter-mounting bore at the emitter position. The arc (54B) is the junction of the emitter-mounting bore and the bulkhead (68). Note that the aperture (44) and the bore (54B) have been moved downward by the applied weight.

The entire scale is shown in FIG. 14A. Other configurations of the scale will be readily apparent to one skilled in the art. For example, the device could be an elongated cube, bored and welded to the load-bearing member. Many other mounting methods will be apparent to those skilled in the art, and all are included in the spirit of the present invention.

In FIG. 14A, both optics are mounted. Three views, B, C, and D, show the sensor package, the emitter package, and the aperture respectively. These views are shown enlarged by FIG. 14B, FIG. 14C, and FIG. 14D. As shown in FIG. 14A, the embodiment is mounted at approximately 90 degrees to the direction of the applied force or weight.

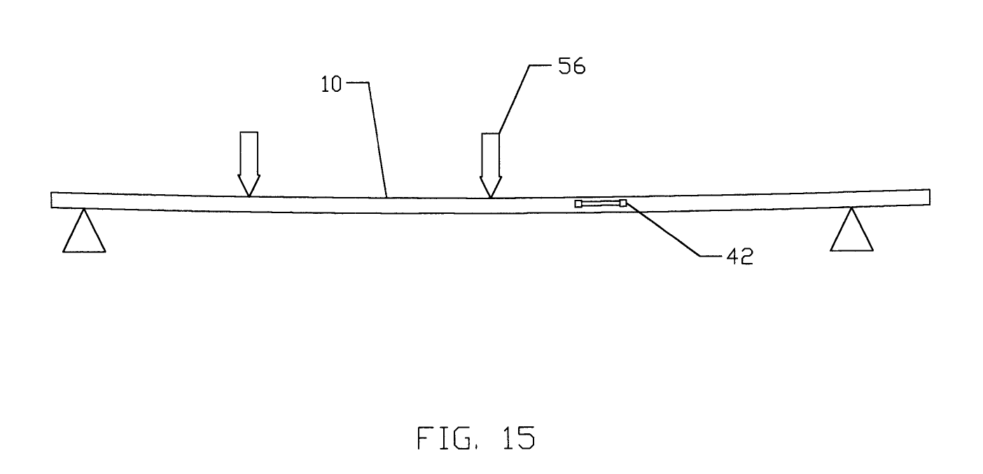

FIG. 15 shows the scale mounted to a load-bearing beam. Note that the scale need not be at the center of the beam or at the center point of the applied load.

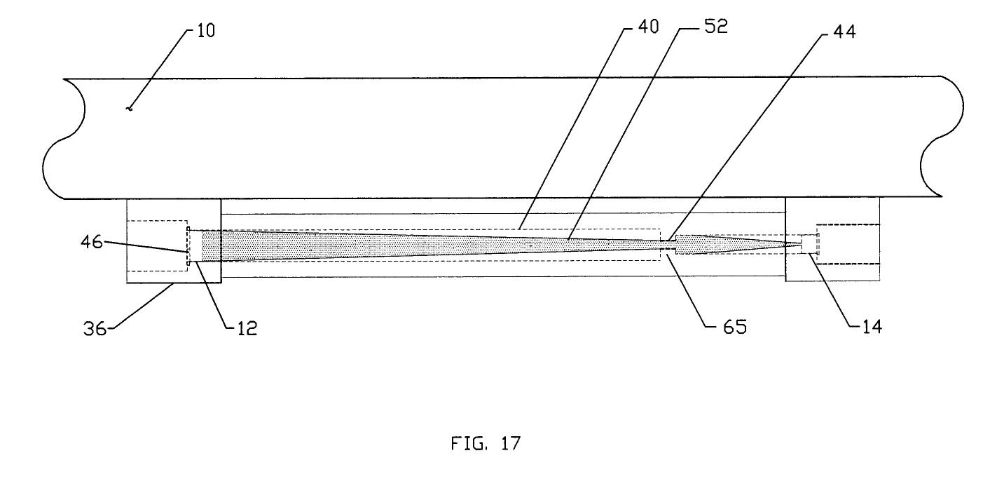

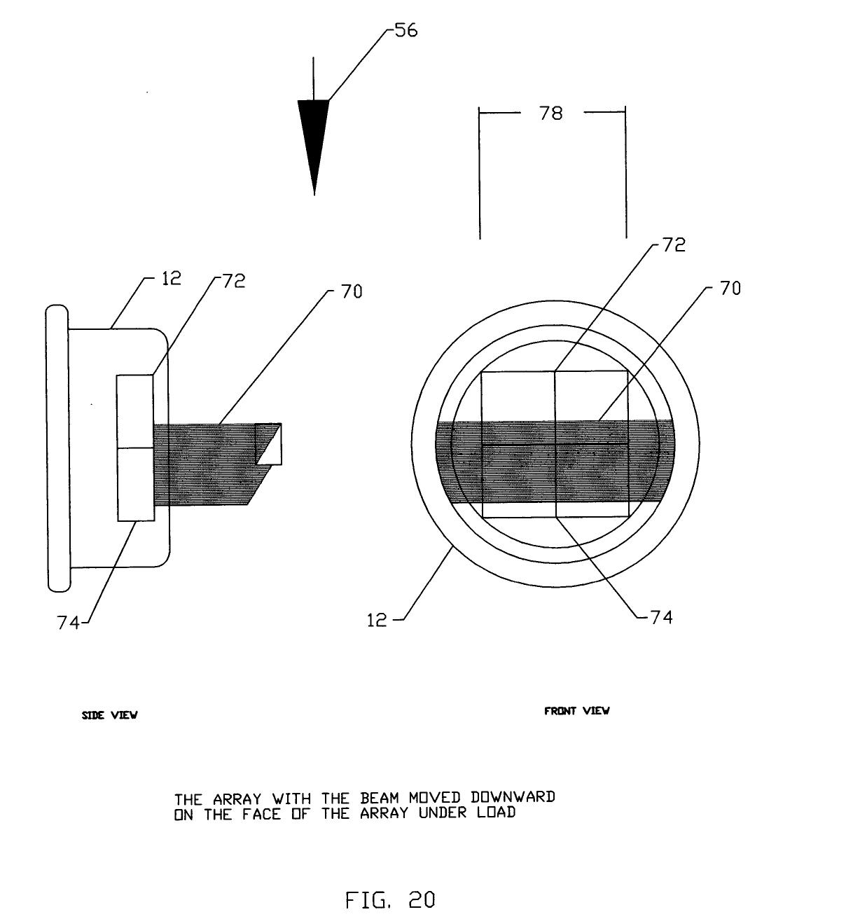

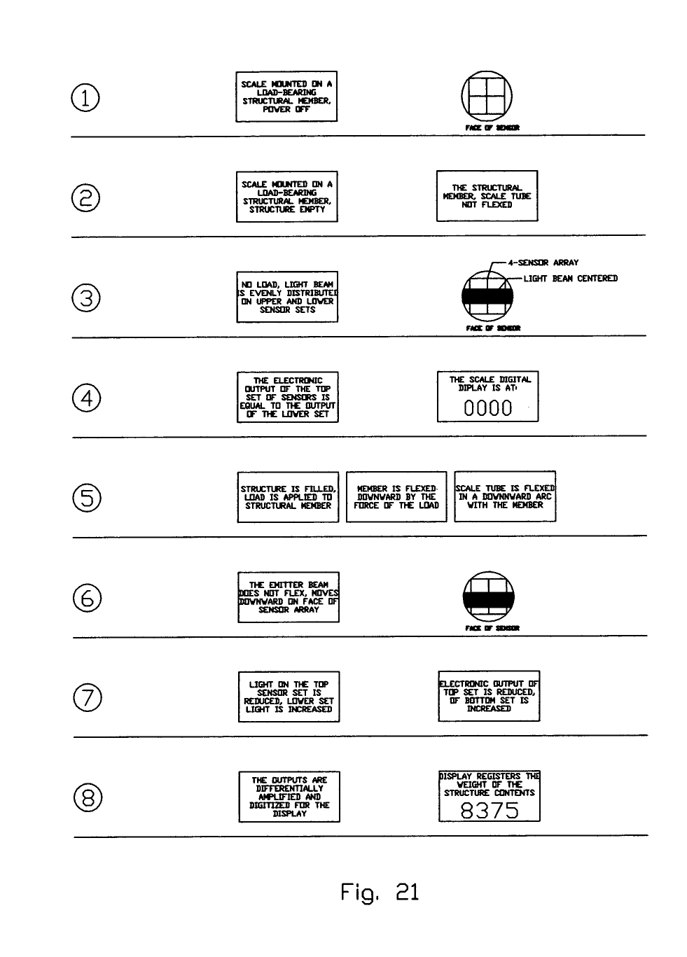

FIG. 17 is a view from the direction of the applied force, or vertical in most applications, showing the wide dimension of the aperture (44). Note that the aperture allows a beam wide enough to cover the width (78) of the photoelectric cell array in the sensor package (46). The width (78) is shown in FIG. 20. The width assures that measurements are linear even when the scale is not precisely aligned at 90° to the weight vector.

As shown in FIG. 18, the scale measures weight by sensing the flexure of a member (10) of the loaded structure. It is anticipated that the weight and/or the structure may be moving. The resulting forces may be many times the forces when the structure and weight are still. Overload protection is unnecessary. Because the structure,—be it a vehicle, building, bridge, etc,—is designed to withstand the applied forces occurring during its usage, the only overload failure mode would be the failure of the structure itself.

Dimensions and configuration of an embodiment of the present invention will vary in accordance with the specific application, the magnitude of the force or weight to be measured, and other factors and these variations are included in the spirit of the present invention. Such variations are readily apparent to those skilled in the art and are included in the spirit of the present invention.

The location of the aperture between the face of the emitter and the center of the stressed beam is affected by the size of the sensing means, the size of the aperture, and the amount of flexure in the loaded beam.

Other variables will change from application to application, and all such configurations are included in the spirit of the present invention. Also, the aperture may be made separately from the structural means and assembled along with the optical means; and this configuration is included in the spirit of the present invention.

Function

The scale measures weight by sensing the flexure of a member (10) of the loaded structure. It is anticipated that the weight and/or the structure may be moving. The resulting forces may be many times the forces when the structure and weight are still. But overload protection is unnecessary. Because the structure,—be it a vehicle, building, bridge, etc,—is designed to withstand the applied forces occurring during its usage, the only overload failure mode would be the failure of the structure itself.

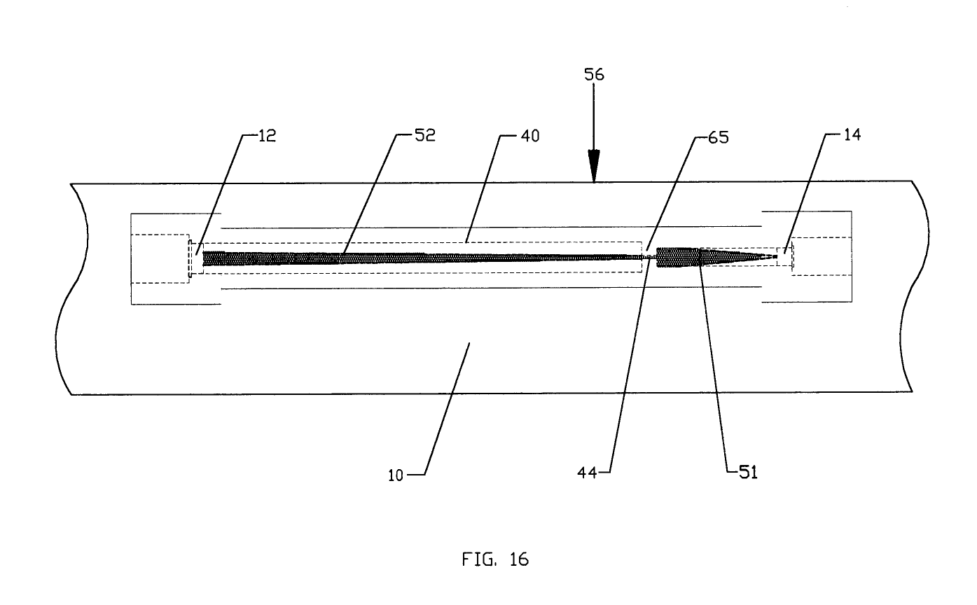

As shown in FIG. 16, a light beam (51) emanates through bore (40) from emitter (14). The bore is through except for a bulkhead (65) which is slotted to form an aperture (44). The aperture (44) allows a beam (52) of emitted light to pass through to the face of the sensor package at the opposite end of the bore. The invention is shown mounted to structural member (10).

The aperture (44) is located proximate the same end as the emitting means (14) and moves generally with the emitting means.

The aperture (44) serves to refine measuring accuracy. Passing through it limits the emitted beam. As shown in FIG. 19, the height of the beam is limited so that it covers only a portion of the photoelectric cell arrays on either side of the horizontal division (76). The portion covered by the beam is approximately the top half of the set (74) below the horizontal division and the bottom half of the set (72) above the horizontal division.

When no force is applied to the structural member (10), aperture (44) is approximately centered in the bore. The beam (52) is approximately centered about the horizontal division of the photoelectric cells in the sensor package. This is shown in FIG. 16 and again in FIG. 19.

FIG. 17 is a view from the direction of the applied force, or vertical in most applications. Note that the aperture (44) allows a beam (52) wide enough to cover the width (78) of the photoelectric cell array in the sensor package (12). Width (78) is shown in FIG. 20.

When the vehicle or structure is loaded as shown in FIG. 18, the force is applied transversely to the through-bore axis. The load flexes the structural member from its unloaded position (64) to a loaded position (63).

Each portion of the member (10) is flexed, including that portion spanned by the scale tube. The flexure over the unsupported segment of the member is proportional to the magnitude of the force or load (56). Thus the flexure of the segment spanned by the tube of the optical sensor scale is equal to that of the tube, since both are firmly affixed to one another. The flexure in the tube, then, is also proportional to the magnitude of the applied force or weight.

The tube flexure causes the aperture (44) to move downward, rotating about a point under the square mount located approximate the emitter. Since the sensor package is not moving downward, the emitter-aperture rotation moves the beam (52) downward across the face of the sensor photoelectric cell array, causing more light to strike the lower set and less light to strike the upper set as shown in FIG. 18 and again in FIG. 20. This causes a change in the electronic output of the sensor. The change is proportional to the movement of the light beam, which is proportional to the magnitude of the applied force. The electronic technology for using optics to measure very small movements is well know to those skilled in the art and is not included in the spirit of the present invention.

The result is a smaller output signal from the upper set and a larger output signal from the lower set. Signals from one cell of the upper set and from one cell of the lower set are differentially amplified and converted to a digital output in the scale electronics. The resulting signal drives a display that shows the weight of the load.

The embodiment of the present invention is rugged enough to function in the hostile environments of toxic materials handling. It requires no modification of the structure, be it the main beam of a bulk-hauling truck or a structural component of a bridge, building, etc.

Being a single part fitted with optics, the scale is neither cumbersome nor delicate. This simple arrangement utilizes the entire device as both housing and heat sink for the optics. The optics are protected by the rugged, low profile tube of the device. Various means may be used to secure the optics in their mounting bores (18) and (50); these means are easily utilized to seal the optics from moisture and dust. The tube also serves as protection for the optics, preventing damage by physical elements inherent in a dynamic environment.

The material used in one embodiment of the present invention is stainless steel; however, other flexible, durable materials could be used as well, and these are included in the spirit of the present invention.

In one embodiment, the optics are an infrared diode emitter (14) and a four-device photoelectric cell array (12). A suitable component for the sensor is the SPOT 4D manufactured by UDT sensors, Inc. A suitable component for the emitter is the OD-880W means from Opto-Diode Corporation. Other optical devices, including lasers or a combination of fiber-optic cable and optics, or a two-photocell device, could be used as well, and such devices are included in the spirit of the present invention.

It should be understood that various modifications within the scope of this invention could be made by one skilled in the art without departing from the spirit thereof. The invention is thus to be defined by the scope of the appended claims as broadly as the prior art will permit, and in view of the specification.

I claim:

1. A scale comprising:
a. a signal emissions device configured for emitting a signal,
b. a receiver device configured for receiving the signal,
wherein the signal emissions device and the receiver device are arranged to measure a deflection of a structural member.

2. The scale according to claim 1 wherein the signal emissions device is an infrared light emitting diode (LED).

3. The scale according to claim 1 wherein the signal emissions device is a laser.

4. The scale according to claim 1 wherein the deflection of the structural member is caused by an applied load.

5. A scale according to claim 1 further comprising a tube, optics, and an amplifying device arranged to measure the deflection of the structural member caused by an applied load.

6. The scale according to claim 5 wherein the tube has a coaxial bore.

7. The scale according to claim 5 wherein the bore has multiple diameters that align the optics.

8. The scale according to claim 5 wherein the tube is mounted in parallel with a transverse axis of a load vector on the structural member.

9. The scale according to claim 5 wherein the tube is mounted such that the tube flexes with the structural member when the applied load contacts the structural member.

10. A scale comprising
optics including a sensor package; and
an emission device configured to communicate with the optics wherein the emission device is configured to transmit a signal through a tube.

11. The scale according to claim 10 wherein the signal from the emission device further comprising a light beam travels through a length of the tube to a face of the sensor array located at an opposite end of the tube.

12. The scale according to claim 10 wherein the sensor package includes a four-cell photoelectric array.

13. The scale according to claim 10 further comprising two two-cell sets which are separated by a division that is parallel to a direction of an applied weight.

14. The scale according to claim 10 further comprising two two-cell sets which are separated by a division that is transverse to a direction of an applied weight.

15. The scale according to claim 10 further comprising four elements which are configured such that one set of two elements is above and one set of two elements is below a separation that is transversely aligned to a direction of an applied weight.

16. The scale according to claim 10 wherein the tube further comprises a bore having a narrow aperture positioned between the emission device and the sensor package and proximate to the emission device.

17. The scale according to claim 16 wherein the narrow aperture restricts the signal from the emissions device.

18. The scale according to claim 16 wherein the narrow aperture is configured to align a wide dimension transversely to a force vector of an applied weight and align a narrow dimension parallel to the force vector of the applied weight.

19. The scale according to claim 16 wherein the narrow aperture is configured to configured such that a long dimension of the signal covers a face of the sensor package.

20. The scale according to claim 16 wherein the narrow aperture includes a narrow dimension that is configured such that approximately half of a face of a four-cell photoelectric array is covered by the signal from the emission device.

21. The scale according to claim 10 wherein the signal covers approximately a lower half of an upper two-cell set and an upper half of a lower two-cell set when the scale is in the no-load condition.

22. The scale according to claim 10 wherein signal covers approximately a lower one-third of an upper two-cell set and an upper two-thirds of a lower two-cell set when the scale is substantially loaded.

23. The scale according to claim 22 wherein a portion of the upper two-cell set remains covered by the signal and a portion of the lower two-cell set remains darkened when a load is applied to the scale.

24. The scale according to claim 10 wherein the optics are protected from contamination, light, and environmental hazards by the tube.

25. The scale according to claim 10 wherein the signal from one cell of the upper set and one cell of the lower set are differentially amplified to obtain a resultant signal that is proportional to a load on the scale.

26. The scale according to claim 10 wherein the signal are amplified to produce a feedback signal for a temperature correction.

27. The scale according to claim 25 wherein the amplification of the resultant signal is converted from analog to digital.
